(19) United States
(12) Patent Application Publication
(10) Pub. No.: US 2015/0066811 A1
(43) Pub. Date: Mar. 5, 2015

(54) Determining Income Replacement Rates

(71) Applicant: FMR LLC, Boston, MA (US)

(72) Inventors: Jonathan Charles Legare, Worcester, MA (US); John Donald Colantino, Winchester, MA (US); Andrew Philip Shaw, Shrewsbury, MA (US); Aditi Sharma, Bangalore (IN); Jeanne Marie Thompson, Exeter, NH (US)

(21) Appl. No.: 14/480,407

(22) Filed: Sep. 8, 2014

Related U.S. Application Data
(62) Division of application No. 14/219,701, filed on Mar. 19, 2014.
(60) Provisional application No. 61/873,236, filed on Sep. 3, 2013.

(51) Int. Cl. G06Q 40/06

(52) U.S. Cl. CPC G06Q 40/06
USPC 705/36 R

(57) ABSTRACT

A computer-implemented method, including executing a plurality of simulations on a retirement account in a retirement plan to produce a plurality of potential retirement account balances at a retirement age and associated confidence levels specifying a predicted level of accuracy of corresponding account balances; selecting, from the range, a particular potential account balance that has a confidence level that exceeds a confidence level threshold; and calculating, by one or more processing devices, a constant periodic withdrawal amount of funds from the retirement account.

### CLAIM OF PRIORITY

This application is a divisional of and claims priority under 35 U.S.C. §121 to U.S. patent application Ser. No. 14/219,701, filed Mar. 19, 2014, which claims priority under 35 U.S.C. §119(e) to provisional U.S. patent application Ser. No. 61/873,236, filed on Sep. 3, 2013, the entire contents of each of which are hereby incorporated by reference.

### BACKGROUND

An income replacement rate is a ratio of retirement income (i.e., after-tax annual income in retirement) to pre-retirement income (i.e., after-tax income in the year prior to retirement). For example, an income replacement rate expresses retirement income as a percentage of pre-retirement income.

Various types of retirement accounts are known. For example, popular types of retirement accounts include 401(k) accounts, where the term 401(k) refers to Title 26—Internal Revenue Code section 401, paragraph (k). Similarly, as discussed herein other numeric references to types of retirement accounts generally will refer to the IRS code. In other jurisdictions, other comparable types of accounts may exist.

### SUMMARY

In an implementation, a computer-implemented method includes executing a plurality of simulations on a retirement account in a retirement plan to produce a plurality of potential retirement account balances at a retirement age and associated confidence levels specifying a predicted level of accuracy of corresponding account balances; selecting, from the range, a particular potential account balance that has a confidence level that exceeds a confidence level threshold; and calculating, by one or more processing devices, a constant periodic withdrawal amount of funds from the retirement account. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In some implementations, the constant periodic withdrawal amount is a constant withdrawal amount from the retirement plan starting in a year after retirement such that the retirement account is depleted when the participant reaches an expected life expectancy. The actions include receiving information indicative of an amount of social security payments the participant is expected to receive annually after retirement; computing an annual retirement income by summing the constant withdrawal amount and the annual amount of social security payments; and computing, based on the annual retirement income and an after-tax income in a year before retirement of the participant, an income replacement rate for a participant, with the income replacement rate being a measure of an amount of after-tax income that a participant received annually during retirement divided by the after-tax income in a year before retirement of the participant. The actions include determining, by the one or more processing devices, an amount of the income replacement rate that is attributable to a defined contribution, with the defined contribution being based on a ratio of the constant withdrawal amount and the after-tax income in the year before retirement of the participant; and determining, by the one or more processing devices, an amount of the income replacement rate that is attributable to the annual amount of social security payment.

The actions include aggregating, for participants in a retirement plan, income replacement rates for the participants; and generating a visualization of average income replacement rates for the participants, with a portion of the visualization specifying an amount of the average income replacement rate that is attributable to defined contributions of the participants in the plan, and with another portion of the visualization specifying an amount of the average income replacement rate that is attributable to social security payments of the participants in the plan. The actions include aggregating, for participants in a retirement plan, income replacement rates for the participants; and generating visualizations of average income replacement rates for different values of a particular participant attribute, with the particular participant attribute comprising one or more of participants' elective deferral rate, participants' tenure at an employer, participants' annual income, participants' account balance at a predefined time, and participants' age of starting to contribute to retirement plans, with the visualizations each comprising a defined contribution component specifying an amount of the average income replacement rate that is attributable to defined contributions of the participants in the plan, and a social security component specifying an amount of the average income replacement rate that is attributable to social security payments of the participants in the plan; and a gender of the participant.

In some implementations, the simulations are Monte Carlo simulations. The actions include accessing information indicative of an expected retirement age of the participant in the retirement plan, information indicative of an annual income of the participant, information indicative of an amount of the employer contribution to the retirement account of the participant, information indicative of a contribution of the participant to the retirement account of the participant, and information indicative of life expectancy of the participant; and accessing information indicative of different market conditions for types of assets in the retirement account. The actions include accessing information indicative of historical performance of types of assets in the retirement account; generating, from the information indicative of the historical performance, different market conditions, with a first one of the different market conditions being that the market performs lower than historical averages for a particular type of asset, and with a second one of the different market conditions being that the market holds at a historical average for the particular type of asset in the retirement account.

The actions include determining asset allocations for types of assets in the retirement account, with the different market conditions being market conditions for the types of assets included in the retirement account and with the simulations being weighted in accordance with the asset allocations of the retirement account. The actions include applying a plurality of simulations to information indicative of the different market conditions for types of assets in a retirement account of a participant, information indicative of an expected retirement age of the participant, information indicative of an annual income of the participant, information indicative of the amount of an employer contribution to the retirement account, and the information indicative of a contribution of the participant to the retirement account.

In another implementation, a computer-implemented method for designing an investment plan, the method comprises: receiving a request to generate an estimate of a hypothetical income replacement rate for a hypothetical participant in a hypothetical retirement plan, with the request including a selected starting age, a selected retirement age, a selected starting salary, a selected starting deferral rate, a selected employer contribution rate, and a selected annual deferral increase in the starting deferral rate; applying a plurality of simulations to information indicative of the different market conditions for types of assets in hypothetical retirement plan, information indicative of the selected retirement age of the participant, information indicative of the selected starting salary, information indicative of the selected starting deferral rate, and information indicative of the selected employer contribution rate; and generating, based on applying, a range of potential account balances for the hypothetical retirement account when the hypothetical participant reaches the selected retirement age, with each of the potential account balances in the range being associated with a confidence level specifying a predicted level of accuracy of the potential account balance; selecting, from the range, a particular potential account balance with a confidence level that exceeds a confidence level threshold; calculating, by one or more processing devices and based on an expected life expectancy of the hypothetical participant, a constant withdrawal amount that specifies a constant amount of funds the hypothetical participant can withdraw from the hypothetical retirement account each year after retirement such that the hypothetical retirement account is depleted when the participant reaches the expected life expectancy; receiving information indicative of an amount of social security payments the hypothetical participant is expected to receive annually after retirement; computing an annual retirement income by summing the constant withdrawal amount and the annual amount of social security payments; and computing, based on the annual retirement income and an after-tax income in a year before retirement of the hypothetical participant, an hypothetical income replacement rate for a participant, with the hypothetical income replacement rate being a measure of on an amount of after-tax income that a participant received annually during retirement divided by the after-tax income in a year before retirement of the hypothetical participant. Other embodiments of this aspect include corresponding computer systems, apparatus, and computer programs recorded on one or more computer storage devices, each configured to perform the actions of the methods.

In some implementations, the hypothetical income replacement rate is a first hypothetical income replacement rate, and wherein the method further comprises: computing a second hypothetical income replacement rate based on another selected starting deferral rate, another selected employer contribution rate, and another selected annual increase; and generating a comparison of the first hypothetical income replacement to the second hypothetical income replacement.

In yet other implementations, a computer-implemented method for designing an investment plan includes generating a simulation of a first income replacement rate for a participant in the investment plan, with the simulated first income replacement rate being based on a first user-specified deferral rate and a first user-specified employer contribution rate; generating a simulation of a second income replacement rate for the participant in the investment plan, with the second income replacement rate being based on a second user-specified deferral rate and a second user-specified employer contribution rate; determining that at least one of the first income replacement rate and the second income replacement rate is an unacceptable income replacement rate; and updating, based on determining, one or more attributes of the plan for the participant, with an attribute comprising one or more of a deferral rate and an employer contribution rate. Other embodiments of this aspect include corresponding computer systems, apparatus, and computer programs recorded on one or more computer storage devices, each configured to perform the actions of the methods.

All or part of the foregoing may be implemented as a computer program product including instructions that are stored on one or more non-transitory machine-readable storage media and/or one or more computer-readable hardware storage devices that are a hard drive, a random access memory storage device, such as a dynamic random access memory, machine-readable hardware storage devices, and other types of non-transitory machine-readable storage devices, and that are executable on one or more processing devices. All or part of the foregoing may be implemented as an apparatus, method, or electronic system that may include one or more processing devices and memory to store executable instructions to implement the stated functions.

The details of one or more embodiments are set forth in the accompanying drawings and the description below. Other features, objects, and advantages of the techniques described herein will be apparent from the description and drawings, and from the claims.

### DESCRIPTION OF DRAWINGS

FIG. 1 is a diagram of a system for determining an income replacement rate.

FIG. 2 is a block diagram of components of a system for determining an income replacement rate.

FIGS. 3-4 are diagrams of graphical user interfaces that are generated by the system for determining an income replacement rate.

FIG. 5-6 are flow charts of processes for determining an income replacement rate.

### DETAILED DESCRIPTION

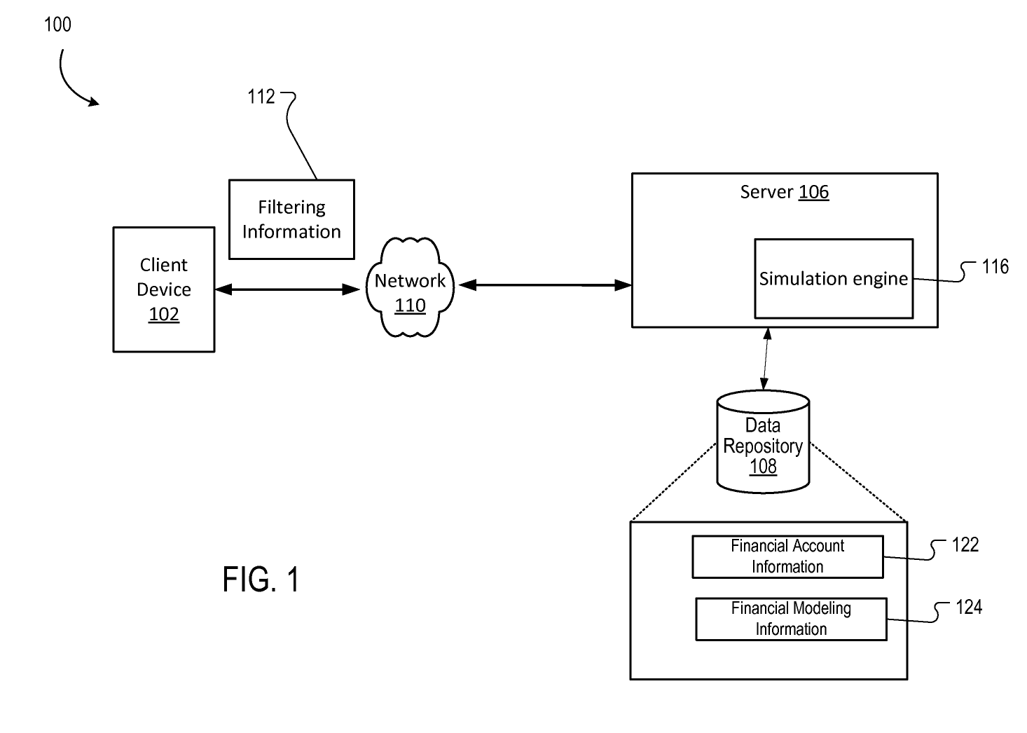

Referring to FIG. 1, system 100 includes server 106 for computing income replacement rates for retirement plans, client device 102, and data repository 108. To determine an income replacement rate for a particular retirement plan or product, server 106 executes simulation engine 116 that applies one or more simulations to financial account information 122 and financial modeling information 124. Financial account information 122 includes information about one or more financial accounts of various users of system 100, including, e.g., types of financial accounts (e.g., savings accounts, checking accounts, retirement accounts, brokerage accounts, etc.) and balances in the various types of accounts. Financial account information 122 also includes salary information for a particular participant of a retirement plan and a salary growth rate (e.g., 1.5%) to enable computations of future, expected salaries for a participant.

Financial account information 122 also includes information indicative of amounts of contributions to retirement plans. For example, the financial account information 122 also can include amounts (e.g., rates) of employee contributions to a retirement plan. An employee contribution is an amount an employee contributes to a retirement plan (e.g., a 401(k)). In a variation, server 106 computes the amount of an employee contribution using a deferral rate (pre and post-tax), e.g., a rate for deferring portions of salary to a retirement account. Using a participant's annual salary, an amount of funds that is diverted to a health savings account and the deferral rate, server 106 determines a contribution dollar amount, e.g., based on the following equation:

Contribution amount=(Annual salary−HSA contributions)×deferral rate

In a variation, data repository 108 stores information indicative of a contribution dollar amount, rather than a deferral rate. In this variation, server 106 determines the deferral rate based on the total contribution dollar amount and the salary amount.

Financial account information 122 also includes information indicative of employer contributions, e.g., an amount an employer contributes to a retirement plan. Employer contributions are based on a predefined number of months of total employer contributions (e.g., the last twelve months of match and profit sharing). Based on an amount an employer contributes to a retirement plan and the salary of the participant, server 106 calculates the employer contribution percentage for a participant.

Financial account information 122 also includes other information indicative of other retirement plans, e.g., conventional employer sponsored pension plans, if any, and prior 401k, 403b, etc. plans, if any.

Financial modeling information 124 includes information specifying a retirement age and information specifying a life expectancy. The financial modeling information 124 is used by simulation engine 116 to perform simulation of balances in retirement accounts under various scenarios. Simulation engine 116 uses a predefined or a user selected retirement age (e.g., a retirement age of sixty-seven). Simulation engine 116 is programmed with conditions specifying when the last contribution is made and when the first withdrawal is made. For example, one set of conditions is that a participant (in a retirement plan) makes the last contribution just prior to reaching the retirement age and makes a first withdrawal from a retirement account after reaching the retirement age.

The simulation executed by simulation engine 116 also uses an individual's life expectancy in performing the calculations. Simulation engine 116 uses a predefined or a user selected life expectancy value and simulation engine 116 is programmed to assume that the participant makes a final withdrawal during the final year of life expectancy.

To determine the income replacement rate for a particular plan (across plan participants), server 106 determines the income replacement rate for each participant in the plan. As previously described, the income replacement rate is a ratio of retirement income (i.e., after-tax annual income in retirement) to pre-retirement income. To determine an amount of retirement income, server 106 executes simulation engine 116 that executes a series of algorithms and simulations (e.g., Monte Carlo simulations) to determine an amount of retirement income.

Simulation engine 116 executes a plurality of simulation models using financial account information 122 and financial modeling information 124, including, e.g., models indicative of different market conditions for types of assets in a retirement account of a participant, information indicative of an expected retirement age of the participant, information indicative of an annual income of the participant, information indicative of the amount of an employer contribution to the retirement account, and the information indicative of a contribution of the participant to the retirement account. Based on the simulations, simulation engine 116 generates a range of potential account balances for the retirement account when the participant reaches an expected retirement age, with each of the potential account balances in the range being associated with a confidence level specifying a predicted level of accuracy of the potential account balance.

Server 106 selects, from the range, a particular potential account balance with a confidence level that exceeds a confidence level threshold. Based on the expected life expectancy of the participant, server 106 calculates a constant withdrawal amount that specifies a constant amount of funds the participant can withdraw from the retirement account each year after retirement such that the particular potential account balance of the retirement account is depleted at a particular age and/or when the participant reaches the expected life expectancy.

In particular, simulation engine 116 uses a Monte Carlo simulation-based approach to estimate potential growth of account balances through retirement, applying market performance assumptions. A Monte Carlo simulation is a mathematical method used to estimate the likelihood of a particular outcome based on market performance historical analysis. Using the Monte Carlo simulation, simulation engine 116 analyzes expected fund performance based on historical market data that incorporates a risk premium approach to project a range of potential outcomes for various hypothetical retirement income portfolios under different market conditions. The Monte Carlo simulations account for change in market conditions. The Monte Carlo simulations are designed to reflect this historical market volatility.

Prior to implementation of the Monte Carlo simulations, simulation engine 116 performs historical performance analysis. Simulation engine 116 identifies an asset allocation (e.g., current asset mix) in a retirement plan for a particular participant. For the type of retirement plan, simulation engine 116 accesses, from data repository 108, information specifying a target asset mix. For modeling purposes, a user of simulation 116 specifies whether to use the target asset mix or the current asset mix in performing the simulations.

A retirement account can include various types of asset classes, including, e.g., stocks, long term debt instructions such as bonds, and short-term debt instruments such as treasury bills and notes or the like, and so forth. Simulation engine 116 accesses, in data repository 108, information indicative of historical correlations and volatilities of the various types of asset classes within the particular account by running hypothetical financial market return scenarios or simulations. Using the historical correlations and volatilities, simulation engine 116 projects the performance of the asset mix in the retirement plan to generate a range of potential returns. The expected returns are based on the risk premium approach, as described in more detail below. Simulation engine 116 also determines confidence levels (e.g., a confidence level of 90%, 75% and so forth) for an expected (i.e., potential) return by determining how a particular asset mix may have performed in a certain percentage of the simulated market scenarios.

A confidence level of 90% is indicative of very conservative market performance and indicates that in 90% of the historical market scenarios run, a target asset mix similar to the current asset mix of selected account or of another target asset mix that the user selected for modeling purposes performed at least as well as a particular result (e.g., a predetermine amount of growth). A confidence level of 10% indicates that in 10% of the historical market scenarios run, a target asset mix similar to the current asset mix of the selected account or of another target asset mix that the used selected, failed to reach the results of particular result. Examples of various confidence levels are shown in Table 1, below.

TABLE 1

| | Performance | Performance | |
|---|---|---|---|
| | Assumptions | Assumptions | Confidence |
| Market Conditions | Fail | Meet or Exceed | Level |
| If markets perform | 1 out of 10 times | 9 out of 10 times | 90% |
| significantly lower than | | | |
| historical averages | | | |
| If market averages | 1 out of 2 times | 1 out of 2 times | 50% |
| continue | | | |

As shown in the above Table 1, the table lists confidence levels for two different market conditions. For the first condition “If markets perform significantly lower than historical averages” the simulation models using the performance assumptions provided for those models fail 1 out of 10 times or in other words meets or exceeds 9 out of 10 times, giving that set of assumptions a 90% confidence level. Conversely, for the condition “If market averages continue” the simulation models using the performance assumptions provided for those models fail 1 out of 2 times or in other words meets or exceeds 1 out of 2 times, giving that set of assumptions a 50% confidence level.

A target asset mix's performance figures are based on the weighted average of annual return figures for various benchmarks for an asset class represented in the target asset mix. Historical returns and volatility of the stock, bond, and short-term asset classes are based on the historical performance data from 1926 through the most recent year-end data available from an external source, e.g., Morningstar. Stocks (domestic and foreign), bonds, and short-term assets are represented by the S&P 500®, U.S. intermediate-term government bonds, and 30-day U.S. Treasury bills, respectively. Foreign equities (prior to 1970) are represented by various foreign indices, e.g., the Morgan Stanley Capital International Europe, Australasia, Far East Index for the period from 1970 to the last calendar year. Foreign equities prior to 1970 are represented by the S&P 500® Index.

Simulation engine 116 generates average annual returns that are hypothetical, and, if achieved annually, would produce the same cumulative total return as if performance had been constant over the entire period. Volatility of the stock (domestic and foreign), bond, and short-term asset classes is based on the historical annual data from 1926 through the most recent year-end data available from Ibbotson Associates, Inc. Stocks (domestic and foreign), bonds, and short-term are represented by the S&P 500® Index, U.S. intermediate-term government bonds, and 30-day U.S. Treasury bills, respectively.

Following, the historical analysis, simulation engine 116 performs various types of historical performance simulations to determine the probability that a portfolio may experience a certain minimum level of performance given market volatility. One type of simulation performed is a Monte Carlo Simulation. Monte Carlo methods (or Monte Carlo experiments) are a broad class of computational algorithms that rely on repeated random sampling to obtain numerical results; typically simulations are performed many times over in order to obtain the distribution of an unknown probabilistic entity.

In implementing a Monte Carlo simulation, simulation engine 116 randomly generate a series of hundreds of returns for a given scenario (e.g., a particular market condition). These various market conditions—in the aggregate provide a probability that a certain amount (or greater) of assets/income occurs at that market condition. In order to implement a Monte Carlo simulation, simulation engine 116 is programmed with the various conditions. Simulation engine 116 selects from a specific statistical distribution random variables, representing asset class returns. The time increment used in the Monte Carlo simulations is a predefined length of time (e.g., one year). Simulation engine 116 generates annual random returns to simulate the mean, standard deviation, distribution, and correlated behavior of observed historical asset class.

In one implementation, the Simulation engine 116 is programmed such that annual returns assume the reinvestment of interest income and dividends, no transaction costs, no management or servicing fees (except for a variable annuity fee) and the rebalancing of the portfolio every year. Other simulations that take into considering costs for example could be used. This calculation is independent of and does not include annual returns of individual securities held by a participant. Rather, simulation engine 116 performs the analysis on asset classes.

A Monte Carlo simulation of capital market returns takes into account expected returns from each asset class (e.g., stocks, bonds, and short-term investments), their volatility, correlations between them, and other factors, based on historical statistics. Simulation engine 116 generates random rates of return by sampling values from a probability distribution such as a bell curve (e.g., “lognormal” distribution). Simulation engine 116 also quantifies various relationships between asset classes and financial products and includes these quantifications in the simulation. One relationship is that returns from stock asset classes (such as Canadian, U.S., or international equities) are historically higher than returns from lower-risk (such as fixed income) or risk-free investments (like cash or GICs). Another relationship is that higher stock returns also have greater risk associated with a wider range of outcomes—from complete loss of capital to appreciation many times over the initial purchase price and also experience greater volatility.

Simulation engine 116 also performs asset allocation to spread investments across various asset classes. While asset allocation does not ensure a profit or guarantee against a loss, dividing holdings among the asset classes of stock, bond, and short-term investments, lowers the risk associated with having money in one type of investment.

Simulation engine 116 selects an asset class mix that is similar to the current asset mix of a selected individual's account. Simulation engine 116 determines a current asset mix based on the types of holdings within that selected account. Simulation engine 116 categorizes a holding by asset class, e.g., stocks, bonds, or short-term investments. Simulation engine 116 retrieves, from data repository 108, holdings data used to classify mutual funds and other financial assets. This holding data is provided by an external, third-party source. Holdings data for publicly available mutual funds is obtained monthly from an independent third-party vendor (e.g., Morningstar, Inc.) In some cases (e.g., newer funds), the third-party vendor may not have holdings information and therefore holding in such funds are classified as “unknown.” In a variation, simulation engine 116 does not recognize the holdings within a mutual fund. In this variation, simulation engine 116 performs analysis only on the recognized holding of the mutual fund. The underlying holdings may not be fully classified, as the unrecognized holdings will not be categorized. The unrecognized holdings are classified as “unknown.”

For proprietary mutual funds and other pooled investment options unique to certain retirement plans (e.g., commingled pools or separate accounts), simulation engine 116 relies on underlying holdings provided (e.g., quarterly) by various third parties, e.g., affiliates, plan sponsors, and external money managers. For assets that are classified as “unknown” or “other,” simulation engine 116 normalizes these assets reflect current allocation to stocks, bonds, and short-term categories.

For purposes of illustration, a hypothetical asset allocation scenario is presented in Table 2 below:

TABLE 2

| | |
|---|---|
| Stocks | 40% |
| Bonds | 20% |
| Short Term | 15% |
| Other | 10% |
| Unknown | 15% |

As shown in the above Table 2, the asset allocation of a particular retirement plan is made-up of forty percent stocks, twenty percent bonds, fifteen percent short term investments, ten percent of other types of investment and fifteen percent unknown types of investments (e.g., investments that simulation engine 116) is unable to classify. Simulation engine 116 combines the percentages of “other” and “unknown” asset types to calculate historical market performance figures. Simulation engine 116 takes the percentage of each known classification (stocks, bonds, and short term) and divides it by the total percentage of stocks, bonds, and short term. This calculation results in a normalized mix percentage adding up to 100%, as shown in the below Table 3:

TABLE 3
Other + Unknown = 25%
Stocks + Bonds + Short Term = 75%
{= 100% − total
for Other and Unknown (25%)}
Stocks % = (40%)/75% = 53%
Bonds % = (20%)/75% = 27%
Short Term = (15%)/75% = 20%

As shown in the above Table 3, simulation engine 116 using the allocations in Table 2 calculates an effective stock allocation of fifty-three percent, a bond allocation of twenty-seven percent and a short term allocation of twenty percent. In a variation, simulation engine 116 calculates the short-term allocation based on the following equation: 100%−(stock allocation %+bond allocation %). The determined allocations, e.g., as shown in Table 3, are used as the current asset mix for a particular retirement plan.

Simulation engine 116 also performs look-through analysis, which is the categorization of a portfolio based on the underlying value and type of assets held in an underlying investment (based on data from the third-party sources). Rather than classifying investments as stocks, bonds, or short-term investments, simulation engine 116 analyzes the underlying holdings of the investments to determine a more accurate exposure to asset classes.

In addition to generating predictions of market performance of a retirement plan based on a current asset mix, simulation engine 116 also predicts growth of a retirement plan based on account contributions, e.g., employer contributions, employee contributions and so forth. Simulation engine 116 generates predictions of potential retirement account balances by executing simulations in which the contributions are used to purchase additional assets in accordance with the current asset mix and the performance of the fund is in accordance with the historical performance.

In generating estimates of amounts of contributions that are made to a plan, simulation engine 116 accesses from data repository 108 contribution limit handler information that is indicative of a set dollar amount contribution limit. Various types of retirement plans (e.g., 401(k), 403(b), 401(a), and 457(b) plans i.e., numeric are references to the Internal Revenue Code) have different contribution limits. Contributions cannot exceed the account's contribution limit, as established by the Internal Revenue Code (IRC) and plan rules, if applicable. Simulation engine 116 uses annual IRC contribution limits to verify that expected contributions are within the specified limit for that account. Simulation engine 116 also applies plan limits or contribution information applicable to the plan, if such information has been supplied by the workplace plan sponsor.

Simulation engine 116 applies IRC annual contribution limitations based on the type of account. Simulation engine 116 also verifies IRC limits on after-tax employee contributions to employer-sponsored accounts. Simulation engine 116 is programmed with the condition that contributions stop at a selected retirement age or when no longer permitted, whichever occurs earlier.

Simulation engine 116 retrieves from data repository 108 contribution limits for 401(k), 403(b), 401(a), and 457(b) plans and information indicative of a current age of a particular participant of the plan. If simulation engine 116 determines that the current age of the participant exceeds a specified age (e.g., fifty years), simulation engine 116 executes rules that enables the predicted account balances to include catch-up contributions allowed under the Economic Growth and Tax Relief Reconciliation Act of 2001 (EGTRRA) for applicable accounts. Simulation engine 116 is programmed with the condition that all contributions, whether made by the participant or the employer, are vested by the participant.

Using the amount of contributions to be added to a retirement plan (until the participant reaches retirement age), the current asset mix, and historical performance for the current asset mix, simulation engine 116 executes a plurality of simulations on a retirement account in the retirement plan to produce a plurality of potential retirement account balances at a retirement age and associated confidence levels specifying a predicted level of accuracy of corresponding account balances (e.g., based on Monte Carlo simulations). Simulation engine 116 selects a potential retirement account balance with a confidence level that exceeds a threshold confidence level. Using the life expectancy of a participant in the retirement plan, simulation engine 116 calculates a constant periodic withdrawal amount of funds from the retirement account starting in a year after retirement such that the retirement account is depleted when the participant reaches the expected life expectancy. Simulation engine 116 and/or server 106 performs the techniques described herein for determining income replacement rates for multiple retirement accounts, e.g., for all of the participants who are enrolled in a particular plan.

Simulation engine 116 determines the post-retirement income based on the constant periodic withdrawal amount and other types of retirement income, including, e.g., social security income and benefits and income from IRAs. Simulation engine 116 generates an estimate of social security income based on the participant's date of birth, most recent earned income amount, and the retirement age, e.g., based on a table or other calculation provided by the Social Security Administration. Simulation engine 116 adjusts an amount of social security retirement benefits by a Cost of Living Adjustment (COLA). Simulation engine 116 also increases the amount of the social security income by a predefined inflation amount (e.g., an annual inflation rate), which is retrieved from data repository 108 and is periodically updated.

Simulation engine 116 also determines expected tax payments in calculating the post-retirement income. Simulation engine 116 retrieves from data repository 108 (or from an external data source) IRS Statistics of Income (SOI) tables. Using the SOI tables, simulation engine 116 determines typical deductions and effective federal tax rates by income ranges and applies those rates to a participant's income. Simulation engine 116 uses a predetermined tax rate (e.g., five percent) for state and local income tax rates. Simulation engine 116 is programmed such that retirement incomes, including but not limited to pensions, part-time jobs, or annuities, are taxable (excluding certain tax-deferred and -advantaged accounts).

Using the constant periodic withdrawal amount, social security income and state and local tax rates, simulation engine 116 determines an amount of post-tax retirement income in accordance with the equations in Table 4:

TABLE 4
Pre-tax annual retirement income = the constant periodic withdrawal
amount + social security income
Post tax annual retirement income = pre-tax annual retirement
income − federal income tax − state/local tax

As shown in Table 4, simulation engine 116 calculates the pre-tax annual retirement income as an aggregate of the constant periodic withdrawal amount and other forms of retirement income, such as, social security income. From the pre-tax annual retirement income, simulation engine 116 determines an amount of federal and local taxes to be paid on the pre-tax annual retirement income. Simulation engine 116 determines the post-tax annual retirement income by subtracting the amount of federal and local income taxes from the pre-tax annual retirement income. Using the post-tax annual retirement income, simulation engine 116 determines the income replacement rate for a particular plan participant by computing the ratio of the post -tax annual retirement income to the post tax annual income the year before retirement. Simulation engine 116 determines retrieves, from data repository 108, information indicative of the post-tax annual income the year before retirement. The information indicative of the post-tax annual income the year before retirement is stored in data repository 108 as part of a participant profile. Server 106 determines income replacement rates for a plurality of the participants in a particular retirement plan.

A user of simulation engine 116 requests to view income replacement rates for the participants of a plan that are filtered by various criteria, e.g., based on deferral rates, age, and so forth. The user uses client device 102 to transmits filtering information 112 to server 106. Based on contents of filtering information 112, server 106 filters income replacement rates based on the criteria specified in filtering information 112, as described in more detail below.

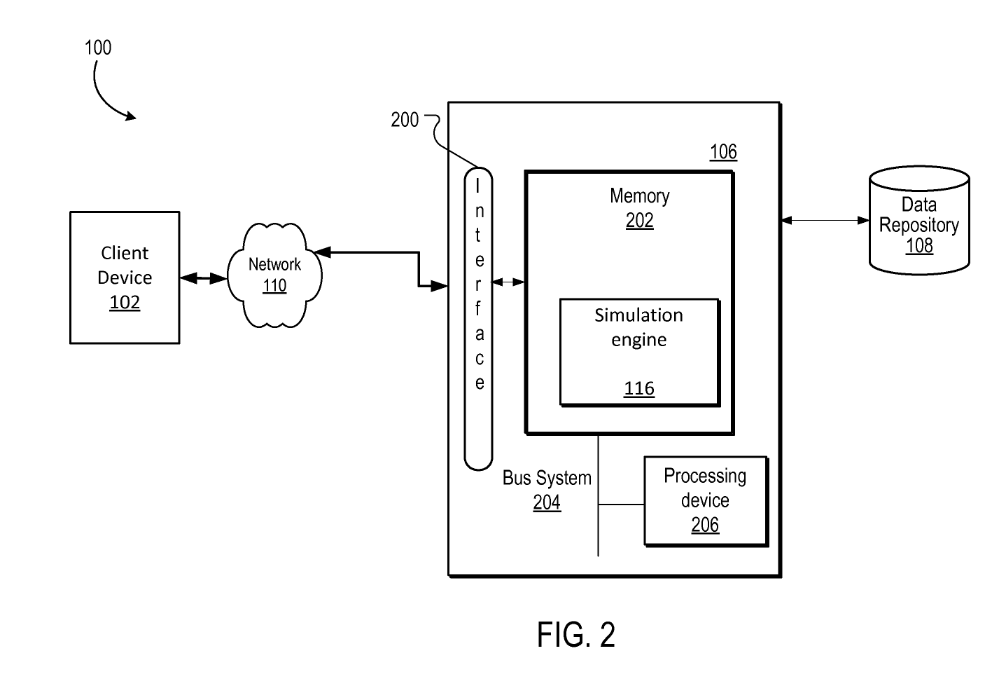

Referring to FIG. 2, client device 102 can be any sort of computing device capable of taking input from a user and communicating over network 110 server 106 and/or with other client devices. For example, client device 102 can be one or more mobile devices, desktop computers, laptops, cell phones, personal digital assistants (“PDAs”), iPhone, smart phones, iPads, servers, embedded computing systems, and so forth.

Server 106 also includes memory 202, a bus system 204, and a processor 206. Memory 202 can include a hard drive and a random access memory storage device, such as a dynamic random access memory, machine-readable media, machine-readable hardware storage devices, or other types of non-transitory machine-readable storage devices. Memory 202 stores various computer programs, e.g., simulation engine 116. A bus system 204, including, for example, a data bus and a motherboard, can be used to establish and to control data communication between the components of communications processing device 106. Processor 206 may include one or more microprocessors and/or processing devices. Generally, processor 206 may include any appropriate processor and/or logic that is capable of receiving and storing data, and of communicating over a network (not shown).

Server 106 can be any of a variety of computing devices capable of receiving data, such as a single server, a distributed computing system, a desktop computer, a laptop, a cell phone, a rack-mounted server, cloud computing device, and so forth. Server 106 may be a single server or a group of servers that are at a same location or at different locations. Communications processing device 106 can receive data from client devices via input/output (“I/O”) interface 200. I/O interface 200 can be any type of interface capable of receiving data over a network, such as an Ethernet interface, a wireless networking interface, a fiber-optic networking interface, a modem, and so forth.

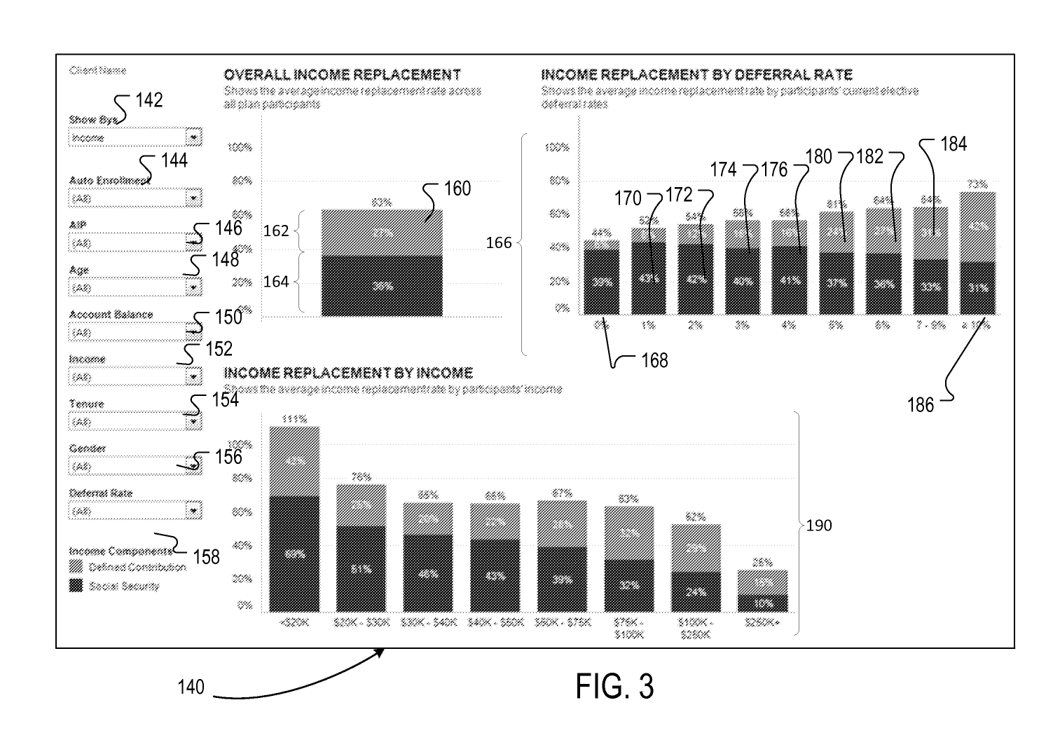

Referring to FIG. 3, server 106 generates graphical user interface 140 that displays controls 142, 144, 146, 148, 150, 152, 154,156,158 for filtering income replacement rates by various criteria. Filter 142 allows for filtering income replacement rates based on the incomes of the participants in the retirement plan. Filter 144 allows for filtering income replacements rates based on an auto enrollment status of participants in the retirement plan. Generally, auto enrollment status specifies whether an individual (e.g., an employee) is automatically enrolled in a retirement plan.

Filter 146 allows for filtering of income replacement rates based on whether a participant is enrolled in an automatic investment plan (AIP), i.e., an investment program that allows investors to contribute small amounts of money (e.g., $20 a month) in regular intervals. Filter 148 allows for filtering of income replacement rates based on age of the participants in the retirement plan. Filter 150 allows for filtering of income replacement rates based on account balances (e.g., of the retirement accounts) of the participants in the retirement plan. Filter 152 allows for filtering of income replacement rates based on income of the participants in the plan. Filter 154 allows for filtering based on tenure status (e.g., whether a participant is a tenured employee) of a participant in a plan. Filter 156 enables filtering of income replacement rates based on the gender of the participants in the plan. Filter 158 enables filtering of income replacement rates by a deferral rate, e.g., a rate at which a participant defers income to the retirement plan.

Server 106 determines an average income replacement rate (IRR) for the participants in a plan in accordance with the formula shown in the below Table 5:

TABLE 5
IRR_{Average} = (IRR₁ + . . . + IRRₙ)/n

As shown in Table 5 above, server 106 determines an average IRR (IRR_{Average}) for the participants in a particular retirement plan for which there are “n” participants. Server 106 determines IRR_{Average} by determining a ratio of the summation of the IRR for the n participants in the retirement plan (i.e., (IRR₁ + . . . +IRRn)) to the number of participants in the retirement plan.

Graphical user interface 140 generates various visual representations, 160, 166, and 190, each of are here depicted as bar graphs that can be color coded to represent retirement sources (in FIG. 3 the bottom portion is social security whereas the top portion is a defined contribution plan). More specifically, visual representation 160 displays a graph of the average income replacement rate (i.e., 63%) for the retirement plan. Visual representation 160 includes portions 162, 164 to specify which portion of the IRR_{Average} is attributable a first retirement income source (i.e., a defined contribution) and which portion of the IRR_{Average} is attributable to a second retirement income source (i.e., social security), respectively. Generally, a defined contribution is a contribution made to a retirement plan (by an employer, employee or both) on a regular basis.

To determine the break-down of types of income sources and amounts that contribute to IRR_{Average}, server 106 accesses, from data repository 108, profile information for the participants in the particular plan, e.g., as shown in the below Table 6:

TABLE 6

| | Annual | | Social | | Constant |
|---|---|---|---|---|---|
| Participant | Income at | Deferral | Security | Defined | Periodic |
| ID | Retirement | Rate | Income | Contribution | Withdrawal |
| 1 | $65,000 | 5% | $1400/mo | $17000/year | $5000/mo |
| 2 | $110,000 | 7% | $1500/mo | $17000/year | $6000/mo |
| . . . | . . . | . . . | . . . | . . . | . . . |
| n | $45,000 | 2% | $1100/mo | %10000/year | $1500/mo |

As shown in the above Table 6, the participant profile includes information indicative of an annual income at retirement, information specifying a deferral rate at which a participant contributes to the retirement plan, an amount of social security income that the participant receives, an amount of a defined contribution to a retirement plan, and an amount of the constant periodic withdrawal.

To determine the portion of IRR that is attributable to a particular source (e.g., defined contribution, social security, and so forth), server 106 determines an amount of retirement income (e.g., for a particular participant and/or for an entire plan) that then determines the amount the particular source contributes to the retirement income. For example, the aggregate retirement income for the participants shown in the above Table 6 is the aggregate of the social security income and the constant periodic withdrawal amounts, as shown in the below Table 7:

TABLE 7
Annual Aggregate Retirement Income_{Plan} =
(Social Security Income₁ + . . . Social Security Incomeₙ) +
(Constant Periodic Withdrawal₁ + . . . Constant Periodic Withdrawalₙ)

Using the value of Aggregate Retirement Income_{Plan}, server 106 determines a portion of the aggregate income replacement rate that is attributable to a particular source, in accordance with the formula shown in the below Table 8:

TABLE 8
Portion of IRR attributable to source = Annual Aggregate Amount from
Source/Annual Aggregate Retirement Income_{Plan}

As shown in the above Table 8, the portion of the income replacement rate (e.g., an aggregate income replacement rate) that is attributable to a particular source is a ratio of the amount of funds that are from the source to the IRR. For example, server 106 determines a portion of the average IRR that is attributable to defined contributions of the participants in accordance with the formula shown in the below Table 9:

TABLE 9
Portion of IRR attributable to defined contributions =
(Defined contribution₁ + . . . + Defined
Contributionₙ)/nnual Aggregate Retirement Income_{Plan}

As shown in the above Table 9, the portion of the average IRR that is attributable to defined contributions of the participants in the plan is the ratio of the aggregate of the amount of defined contributions for the participants in the plan to the annual aggregate retirement income for the plan.

Still referring to FIG. 3, graphical user interface 140 also includes visual representation 166 that displays income replacement rates by deferral rate. Visual representation 166 includes statistical bars 168, 170, 172, 174, 176, 180, 182, 184, 186 that represent the income replacement rates at various deferral rates. The statistical bars 168, 170, 172, 174, 176, 180, 182, 184, 186 can be color-coded to represent portions of the income replacement rate for a particular deferral rate that are attributable to various sources (e.g., a defined contribution source, a social security source, and so forth). Graphical user interface 140 also includes visual representation 190 that displays income replacement rates by income of the participants in the retirement plan.

To filter income replacement rates by various criteria (e.g., by deferral rate), server 106 determines particular values or ranges of values that represent the criteria (e.g., a deferral rate of 1%, 2%, 3%, 4%, 5%, 6%, 7-9% and greater than 10%). For a particular value (or range of values), server 106 selects participant profiles that includes values that match the particular criteria value (e.g., a deferral rate of 2%). Server 106 determines income replacement rates for the selected participant profiles.

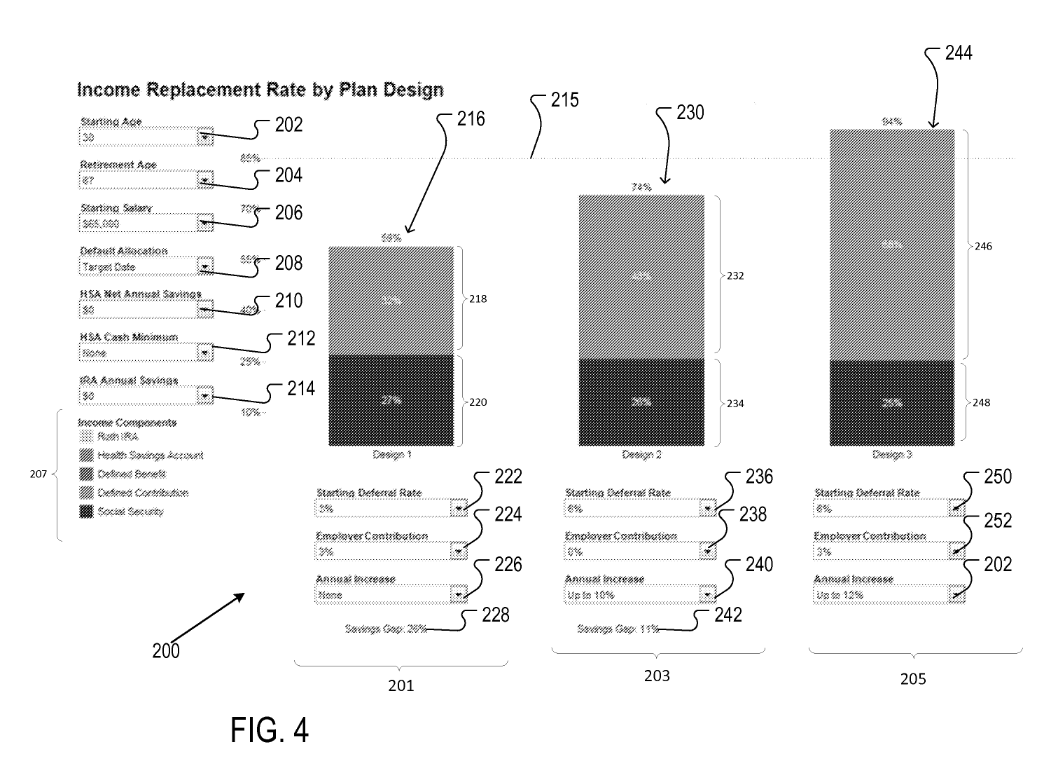

Referring to FIG. 4, server 106 generates graphical user interface 200 that displays a plan design tool to promote designing a retirement plan that satisfies various criteria, including, e.g., a threshold income replacement rate. Generally, a threshold income replacement rate is user specified and/or a system calculated predefined income replacement rate that satisfies one or more criteria, e.g., an industry standard of an acceptable income replacement rate. In an example, the threshold income replacement rate is 85%, which is a benchmark income replacement rate that the finance industry has determined to be sufficient for an individual to comfortably retire. Graphical user interface 200 includes controls 202, 204, 206, 208, 210, 212, 214 for specifying participant attributes to be used in determining the income replacement rate for various plan designs. Age control 202 enables a user to specify an age of a participant. Retirement age control 204 enables a user to specify a retirement age of a participant. Salary control 206 enables a user to specify a starting salary to be used. Control 208 enables a user to select a default allocation type, which is the plan investment default or an assumed flat rate of return. The user has the choice of two options to model investment growth: a plan investments default fund, for example a target date fund or a conservative option and the model would utilize Monte Carlo simulations to project the results, or the user could input an assumed flat rate of return (3%, 5% etc . . . ) rather than utilizing an investment default fund to project growth. Control 210 allows a user to enter an amount of funds that are contributed to a health savings account (HSA). Control 212 allows a user to specify a minimum amount of funds that may be contributed to an HAS. Control 214 enables a user to specify an amount of funds that are contributed to an individual retirement account (IRA).

Graphical user interface 200 includes portions 201, 203, 205 for display of information indicative of different retirement design plans. For a first retirement design plan, which is represented by portion 201, controls 222, 224, 226 enable a user to specify a starting deferral rate, an employer contribution amount and an annual increase in one or more of the deferral rate and the employer contribution amount, respectively. Using the values specified by controls 222, 224, 226 and controls 202, 204, 206, 208, 210, 212, 214, simulation engine 116 determines what the income replacement rate would be if a participant with the attributes specified by controls 202, 204, 206, 208, 210, 212, 214, 222, 224, 226 participated in a retirement plan of a plan sponsor. In addition to the attributes specified by these controls, simulation engine 116 may also use other criteria, e.g., a fixed rate of return. In determining the income replacement rate, simulation engine 116 uses retirement income amounts from multiple retirement income sources, including, a retirement plan, IRAs and social security income sources.

For the first retirement plan represented by portion 201, simulation engine 116 determines a constant periodic withdrawal amount. In making this determination, simulation engine 116 generates a prediction of the amount of funds in the retirement plan at the retirement age specified by control 204. The amount of funds in the retirement plan at the retirement age is based on the starting salary of the participant, annual increases in that salary, pre-tax contributions to IRAs and HSAs, employee deferral rates to the retirement plan (and yearly increases—if any), employer contributions to the retirement plan (and yearly increases—if any) and growth in savings of the retirement plan (e.g., due to performance of the underlying funds in the retirement plan), as shown by the formulas in the below Tables 10-14:

TABLE 10
Deferral Salary _{year 30} = Starting Salary − HSA
contributions − IRA contributions
. . .
Deferral Salary _{year n} = Salary_{year n-1} + Annual
Increase(Salary_{year n-1}), -HSA
contributions − IRA contributions

As shown in the above Table 10, simulation engine 116 determines deferral salaries for the year the participant start participating in the retirement plan (i.e., year 30) until the participant reaches retirement age (i.e., year 67). Generally, a deferral salary is an amount of pre-tax dollars that is eligible for contribution to a retirement account and is exclusive of HSA contributions and IRA contributions. Using controls 202 and 204, a user has specified that the starting age of the participant starting to participate in the retirement account is age 30 and the retirement age is age 67. The user has also selected controls 206, 210, 214 to specify a starting salary (at age 30), an amount of funds that are contributed to an HSA account, and an amount of funds that are contributed to an IRA.

Using the deferral salaries from when the participant starts participating in the retirement age until retirement, simulation engine 116 determines contributions amounts, as shown in Table 11 below:

TABLE 11
Contributions Amount _{year 30} = Deferral Rate _{year 30} (Deferral
Salary _{year 30}) + Employer Contribution Rate _{year 30}
(Deferral Salary _{year 30})
. . .
Contributions Amount _{year n} = ((Deferral Rate _{year n-1} +
Increase)(Deferral Salary _{year n})) + ((Employer
Contribution Rate _{year n-1} + Increase)(Deferral Salary _{year n}))

As shown in the above Table 11, simulation engine 116 determines contribution amounts to the retirement plan (that is being designed) for the year in which the participant begins participating in the retirement account until retirement. The contribution amounts are based on the deferral rate (as specified by control 222), the employer contribution amount (as specified by control 224) and the annual increase (in one or more of the deferral amounts and the employer contribution amounts) (as specified by control 226). Using the contribution amounts, simulation engine 116 predicts balances of the retirement plan that is being designed, as shown in the below Table 12:

TABLE 12
Retirement Plan Balance _{year 30} = Predicted performance(Contributions
Amount _{year 30})
. . .
Retirement Plan Balance _{year n} = Predicted performance (Retirement Plan
Balance _{year n-1} + Contributions Amount _{year n})
. . .
Retirement Plan Balance _{year 67} = Predicted performance (Retirement Plan
Balance _{year 66} + Contributions Amount _{year 67})

As shown in the above Table 12, simulation engine 112 predicts the balance of the retirement plan being designed based on the amount of funds being contributed to the retirement plan for the particular year, based on the balance of the retirement plan in the prior year (i.e., the closing balance) and the expected performance of the plan. The performance amount is based on the allocation of funds in the account and based on execution of the historical performance analysis and simulations previously described. Simulation engine 116 generates predictions of balances of the candidate retirement plan from the year in which the participant joins the plan until the age of retirement. Using the predicted balance of the retirement plan at the age of retirement, simulation engine 116 determines the constant periodic withdrawal amount, in accordance with the formula shown in the below Table 13:

TABLE 12
Constant Periodic Withdrawal Amount = Retirement Plan Balance year 67/
(Age at death − retirement Age + 1)

As shown in the above Table 13, the constant periodic withdrawal amount is the balance of the retirement plan at the retirement age (i.e., age 67) divided by the numbers of years from retirement until death. Using the constant periodic withdrawal amount, simulation engine 116 determines the income replacement rate, in accordance with the formula shown in the below Table 14:

TABLE 14
Income replacement rate = (Constant Periodic Withdrawal Amount + Social
Security Amount + IRA distributions)/Salary _{year 67}

As shown in Table 14 above, simulation engine 116 determines the income replacement rate of a candidate retirement plan using a ratio of the aggregate sum of retirement income resources to the salary at the age of retirement. There are various retirement income resources, including, e.g., constant periodic withdrawal amount, social security, HSA distributions, defined benefits, non-qualified benefit resources and IRA distributions. Simulation engine 116 determines IRA distributions from accessing in data repository 108 (or an external data source) information specifying an annual amount of IRA distributions that are allowed post-retirement.

Still referring to FIG. 4, simulation engine 116 uses values selected for controls 222, 224, 226 to determine the income replacement rate for the first design retirement plan represented by portion 201. Simulation engine 116 generates visual representation 216 to display an amount of the income replacement rate (i.e., 59%). Simulation engine 116 also determines how much various sources contribute to the income replacement rate. The types of sources that contribute to the income replacement is shown in portion 207 of graphical user interface 200. There are various types of sources, including, an IRA, a HSA account, a defined benefit, a defined contribution and social security. A defined benefit retirement plan is a type of retirement plan in which an employer/sponsor promises a specified monthly benefit on retirement that is predetermined by a formula based on the employee's earnings history, tenure of service and age, rather than depending directly on individual investment returns. Visual representation 216 includes portion 218, 220, to specify the amounts of the income replacement rate that are attributable to a defined contribution and social security, respectively.

Graphical user interface 200 also includes a representation 215 to specify a threshold income replacement rate (i.e., of 85%). Simulation engine 116 determines whether the plan design of the first candidate retirement plan represented in portion 201 has an income replacement rate that satisfies the threshold income replacement rate. The income replacement rate of the first candidate plan is less than the threshold income replacement rate. Simulation engine 116 generates savings gap information 228 to specify an amount by which the income replacement rate of the first candidate plan is less than the threshold income replacement rate.

Graphical user interface 200 also includes visual representations 230, 244 of income replacement rates of second and third candidate retirement plans, respectively. Visual representation 230 includes portions 230, 234 to specify which sources contribute to the income replacement rate of the second candidate plan. Visual representation 244 includes portions 246, 248 to specify which sources contribute to the income replacement rate of the third candidate plan. The second candidate plan also has an income replacement rate that is less than the threshold income replacement rate. Simulation engine 116 generates savings gap information 242 to specify the amount by which the income replacement rate for the second candidate retirement plan is less than the threshold income replacement rate.

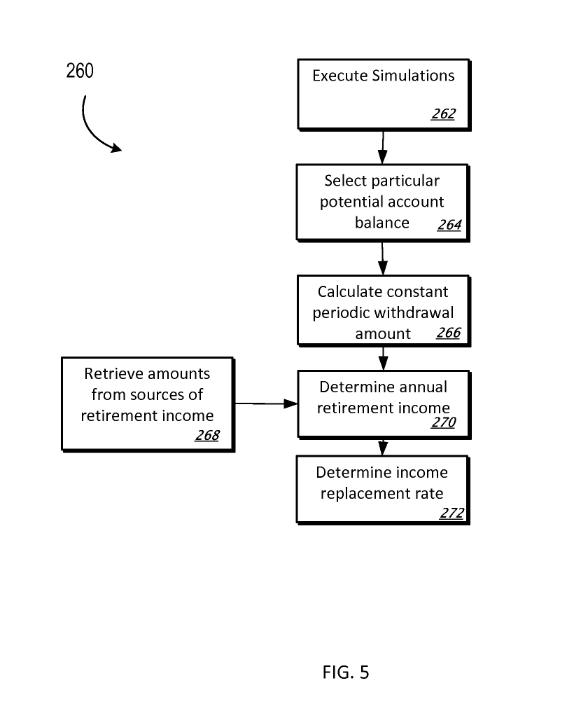

Referring to FIG. 5, simulation engine 116 implements process 260 to determine an income replacement rate. Simulation engine 116 executes (262) executing a plurality of simulations on a retirement account in a retirement plan to produce a plurality of potential retirement account balances at a retirement age and associated confidence levels specifying a predicted level of accuracy of corresponding account balances. Simulation engine 116 selects (264) selecting, from the range, a particular potential account balance that has a confidence level that exceeds a confidence level threshold. Simulation engine 116 calculates (266), based on life expectancy of a participant in the retirement plan, a constant withdrawal amount of funds from the retirement account starting in a year after retirement such that the retirement account is depleted when the participant reaches the expected life expectancy. Simulation engine 116 retrieves (268), from a data repository, information indicative of amount of retirement income from various income sources, including, e.g., social security, HSA distributions, IRA distributions, and so forth. Simulation engine 116 determines an annual retirement income by summing the constant withdrawal amount and the amount of retirement income from the other sources (e.g., the annual amount of social security payments). Simulation engine 116 determines (272); based on the annual retirement income and an after-tax income in a year before retirement of the participant, an income replacement rate for a participant, with the income replacement rate being a measure of an amount of after-tax income that a participant received annually during retirement divided by the after-tax income in a year before retirement of the participant.

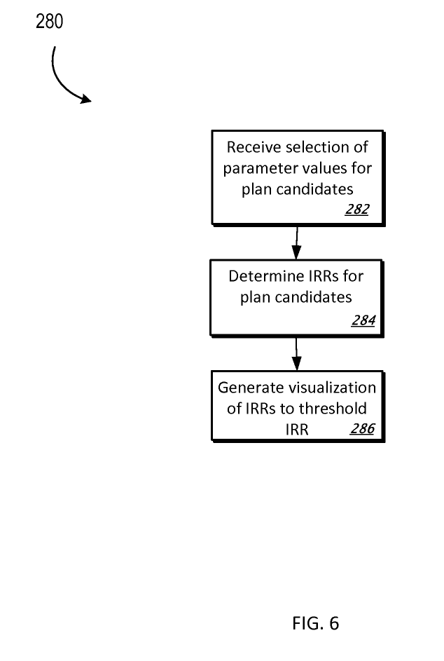

Referring to FIG. 6, simulation engine 116 implements process 280 for the designing of a potential plan by receiving (282), from a user, information indicative of a selection of parameter values for various retirement plan candidates. Parameter values includes values specifying deferral rate, employer contribution, starting salary, retirement age, and so forth. Simulation engine 116 determines (284) income replacement rates for the various candidate plans. Simulation engine 116 also generates (286) visualizations that represent a comparison of the income replacement rates for the candidate plans to a threshold income replacement rates. Based on the comparison, a user updates one or more of the parameter values and/or selects a particular one of the candidate plans as a retirement plan that is offered to participants.

Embodiments can be implemented in digital electronic circuitry, or in computer hardware, firmware, software, or in combinations thereof. Apparatus of the invention can be implemented in a computer program product tangibly embodied or stored in a machine-readable storage device for execution by a programmable processor; and method actions can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD_ROM disks. Any of the foregoing can be supplemented by, or incorporated in, ASICs (application-specific integrated circuits).

Other embodiments are within the scope and spirit of the description claims. For example, due to the nature of software, functions described above can be implemented using software, hardware, firmware, hardwiring, or combinations of any of these. Features implementing functions may also be physically located at various positions, including being distributed such that portions of functions are implemented at different physical locations.

1.-25. (canceled)

26. A computer-implemented method for designing an investment plan, the method comprises:
receiving a request to generate an estimate of a hypothetical income replacement rate for a hypothetical participant in a hypothetical retirement plan, with the request including a selected starting age, a selected retirement age, a selected planning age indicative of an age of death, a selected starting salary, a selected salary growth rate, a selected starting deferral rate, a selected employer contribution rate, a selected annual deferral increase in the starting deferral rate, a selected maximum rate to the annual deferral increase and a selected starting account balance;
applying a plurality of simulations to information indicative of the different market conditions for types of assets in a hypothetical retirement plan, information indicative of the selected retirement age of the participant, information indicative of the selected starting salary, information indicative of the selected starting deferral rate, information indicative of the selected employer contribution rate, and information indicative of a starting account balance; and
generating, based on applying, a range of potential account balances for the hypothetical retirement account when the hypothetical participant reaches the selected retirement age, with each of the potential account balances in the range being associated with a confidence level specifying a predicted level of accuracy of the potential account balance;
selecting, from the range, a particular potential account balance with a confidence level that exceeds a confidence level threshold;
calculating, by one or more processing devices and based on a selected life expectancy of the hypothetical participant, a constant withdrawal amount that specifies a constant amount of funds the hypothetical participant can withdraw from the hypothetical retirement account each year after retirement such that the hypothetical retirement account is depleted when the participant reaches the selected life expectancy;
receiving information indicative of an amount of social security payments the hypothetical participant is expected to receive annually after retirement;
computing an annual retirement income by summing the constant withdrawal amount and the annual amount of social security payments; and
computing, based on the annual retirement income and an after-tax income in a year before retirement of the hypothetical participant, a hypothetical income replacement rate for a participant, with the hypothetical income replacement rate being a measure of on an amount of after-tax income that a participant received annually during retirement divided by the after-tax income in a year before retirement of the hypothetical participant.

27. The computer-implemented method of claim 26, wherein the hypothetical income replacement rate is a first hypothetical income replacement rate, and wherein the method further comprises:
computing a second hypothetical income replacement rate based on another selected starting deferral rate, another selected employer contribution rate, another selected annual increase, and another selected maximum rate to the annual increase; and
generating a comparison of the first hypothetical income replacement to the second hypothetical income replacement.

28. The computer-implemented method of claim 26, wherein the hypothetical income replacement rate comprises a first hypothetical income replacement rate, and wherein the method further comprises:
computing a second hypothetical income replacement rate
determining that at least one of the first hypothetical income replacement rate and the second hypothetical income replacement rate is an unacceptable income replacement rate; and
updating, based on determining, one or more attributes of the plan for the participant, with an attribute comprising one or more of a deferral rate and an employer contribution rate.

29. The computer-implemented method of claim 26, wherein the plurality of simulations comprise Monte Carlo simulations to estimate expected fund performance based on historical market data that incorporates a risk premium to project a range of potential outcomes for various hypothetical retirement income portfolios under different market conditions.

30. The computer-implemented method of claim 26, further comprising:
updating one or more of the selected starting age, the selected retirement age, the selected planning age, the selected starting salary, the selected salary growth rate, the selected starting deferral rate, the selected employer contribution rate, the selected annual deferral increase in the starting deferral rate, the selected maximum rate to the annual deferral increase and the selected starting account balance; and
computing, based on updating, an updated hypothetical income replacement rate.

31. The computer-implemented method of claim 30, further comprising:
generating by the one or more processing devices a visual comparison between the hypothetical income replacement rate and the updated hypothetical income replacement rate.

32. One or more machine-readable hardware storage devices storing instructions that are executable by one or more processing devices to perform operations for designing an investment plan, the operations comprising:
receiving a request to generate an estimate of a hypothetical income replacement rate for a hypothetical participant in a hypothetical retirement plan, with the request including a selected starting age, a selected retirement age, a selected planning age indicative of an age of death, a selected starting salary, a selected salary growth rate, a selected starting deferral rate, a selected employer contribution rate, a selected annual deferral increase in the starting deferral rate, a selected maximum rate to the annual deferral increase and a selected starting account balance;
applying a plurality of simulations to information indicative of the different market conditions for types of assets in a hypothetical retirement plan, information indicative of the selected retirement age of the participant, information indicative of the selected starting salary, information indicative of the selected starting deferral rate, information indicative of the selected employer contribution rate and information indicative of a starting account balance; and
generating, based on applying, a range of potential account balances for the hypothetical retirement account when the hypothetical participant reaches the selected retirement age, with each of the potential account balances in the range being associated with a confidence level specifying a predicted level of accuracy of the potential account balance;
selecting, from the range, a particular potential account balance with a confidence level that exceeds a confidence level threshold;
calculating, based on a selected life expectancy of the hypothetical participant, a constant withdrawal amount that specifies a constant amount of funds the hypothetical participant can withdraw from the hypothetical retirement account each year after retirement such that the hypothetical retirement account is depleted when the participant reaches the selected life expectancy;
receiving information indicative of an amount of social security payments the hypothetical participant is expected to receive annually after retirement;
computing an annual retirement income by summing the constant withdrawal amount and the annual amount of social security payments; and
computing, based on the annual retirement income and an after-tax income in a year before retirement of the hypothetical participant, a hypothetical income replacement rate for a participant, with the hypothetical income replacement rate being a measure of on an amount of after-tax income that a participant received annually during retirement divided by the after-tax income in a year before retirement of the hypothetical participant.

33. The one or more machine-readable hardware storage devices of claim 32, wherein the hypothetical income replacement rate is a first hypothetical income replacement rate, and wherein the operations further comprise:
computing a second hypothetical income replacement rate based on another selected starting deferral rate, another selected employer contribution rate, another selected annual increase, and another selected maximum rate to the annual increase; and
generating a comparison of the first hypothetical income replacement to the second hypothetical income replacement.

34. The one or more machine-readable hardware storage devices of claim 32, wherein the hypothetical income replacement rate comprises a first hypothetical income replacement rate, and wherein the operations further comprise:
computing a second hypothetical income replacement rate
determining that at least one of the first hypothetical income replacement rate and the second hypothetical income replacement rate is an unacceptable income replacement rate; and
updating, based on determining, one or more attributes of the plan for the participant, with an attribute comprising one or more of a deferral rate and an employer contribution rate.

35. The one or more machine-readable hardware storage devices of claim 32, wherein the plurality of simulations comprise Monte Carlo simulations to estimate expected fund performance based on historical market data that incorporates a risk premium to project a range of potential outcomes for various hypothetical retirement income portfolios under different market conditions.

36. The one or more machine-readable hardware storage devices of claim 32, wherein the operations further comprise:
updating one or more of the selected starting age, the selected retirement age, the selected starting salary, the selected salary growth rate, the selected starting deferral rate, the selected employer contribution rate, the selected annual deferral increase in the starting deferral rate, the selected maximum rate to the annual deferral increase and the selected starting account balance; and
computing, based on updating, an updated hypothetical income replacement rate.

37. The one or more machine-readable hardware storage devices of claim 36, wherein the operations further comprise:
generating a visual comparison between the hypothetical income replacement rate and the updated hypothetical income replacement rate.

38. An electronic system comprising:
one or more processing devices; and
one or more machine-readable hardware storage devices storing instructions that are executable by the one or more processing devices to perform operations for designing an investment plan, the operations comprising:
receiving a request to generate an estimate of a hypothetical income replacement rate for a hypothetical participant in a hypothetical retirement plan, with the request including a selected starting age, a selected retirement age, a selected planning age indicative of an age of death, a selected starting salary, a selected salary growth rate, a selected starting deferral rate, a selected employer contribution rate, a selected annual deferral increase in the starting deferral rate, a selected maximum rate to the annual deferral increase and a selected starting account balance;
applying a plurality of simulations to information indicative of the different market conditions for types of assets in a hypothetical retirement plan, information indicative of the selected retirement age of the participant, information indicative of the selected starting salary, information indicative of the selected starting deferral rate, information indicative of the selected employer contribution rate and information indicative of a starting account balance; and
generating, based on applying, a range of potential account balances for the hypothetical retirement account when the hypothetical participant reaches the selected retirement age, with each of the potential account balances in the range being associated with a confidence level specifying a predicted level of accuracy of the potential account balance;
selecting, from the range, a particular potential account balance with a confidence level that exceeds a confidence level threshold;
calculating, based on a selected life expectancy of the hypothetical participant, a constant withdrawal amount that specifies a constant amount of funds the hypothetical participant can withdraw from the hypothetical retirement account each year after retirement such that the hypothetical retirement account is depleted when the participant reaches the selected life expectancy;
receiving information indicative of an amount of social security payments the hypothetical participant is expected to receive annually after retirement;
computing an annual retirement income by summing the constant withdrawal amount and the annual amount of social security payments; and
computing, based on the annual retirement income and an after-tax income in a year before retirement of the hypothetical participant, a hypothetical income replacement rate for a participant, with the hypothetical income replacement rate being a measure of on an amount of after-tax income that a participant received annually during retirement divided by the after-tax income in a year before retirement of the hypothetical participant.

39. The electronic system of claim 38, wherein the hypothetical income replacement rate is a first hypothetical income replacement rate, and wherein the operations further comprise:
computing a second hypothetical income replacement rate based on another selected starting deferral rate, another selected employer contribution rate, another selected annual increase, and another selected maximum rate to the annual increase; and
generating a comparison of the first hypothetical income replacement to the second hypothetical income replacement.

40. The electronic system of claim 38, wherein the hypothetical income replacement rate comprises a first hypothetical income replacement rate, and wherein the operations further comprise:
computing a second hypothetical income replacement rate
determining that at least one of the first hypothetical income replacement rate and the second hypothetical income replacement rate is an unacceptable income replacement rate; and
updating, based on determining, one or more attributes of the plan for the participant, with an attribute comprising one or more of a deferral rate and an employer contribution rate.

41. The electronic system of claim 38, wherein the plurality of simulations comprise Monte Carlo simulations to estimate expected fund performance based on historical market data that incorporates a risk premium to project a range of potential outcomes for various hypothetical retirement income portfolios under different market conditions.

42. The electronic system of claim 38, wherein the operations further comprise:
updating one or more of the selected starting age, the selected retirement age, the selected planning age, the selected starting salary, the selected salary growth rate, the selected starting deferral rate, the selected employer contribution rate, the selected annual deferral increase in the starting deferral rate, the selected maximum rate to the annual deferral increase and the selected starting account balance; and
computing, based on updating, an updated hypothetical income replacement rate.

43. The electronic system of claim 42, wherein the operations further comprise:
generating a visual comparison between the hypothetical income replacement rate and the updated hypothetical income replacement rate.
